(19) United States
(12) Patent Application Publication
(10) Pub. No.: US 2006/0019551 A1
(43) Pub. Date: Jan. 26, 2006

(54) Method of manufacturing a product having encapsulated electronic components

(76) Inventor: Mohammad Ali Jamnia, Chicago, IL (US)

Correspondence Address: ROBERT L. MARSH, 54 DANADA DRIVE, P.O. BOX 4468, WHEATON, IL, 60187-4468, US

(21) Appl. No.: 10/895,742

(22) Filed: Jul. 21, 2004

(51) Int. Cl. H01R 13/405

(52) U.S. Cl. 439/736

(57) ABSTRACT

A product having a plastic body with mechanical properties and having electronic components therein is made in two steps. In the first step an outer housing is injection molded using a thermoplastic process. The outer housing has a cavity therein and the outer body is then inserted into a second mold. In the second step an inner housing containing the electronic components is transfer molded using a thermoset process in a second mold that includes the cavity of the outer housing.

The present invention relates to the inexpensive manufacture of products having electronic components encapsulated in plastic housings.

### BACKGROUND OF THE INVENTION

Products such as fuel level detectors of the type mounted within the fuel tanks of automobiles or other vehicles incorporate electronic components, which must be protected against the corrosive effects of the fuel stored within the tank. To protect the electronic components from corrosion, it is desirable to embed the electronic components into a molded plastic housing or the like.

The most inexpensive method of making a plastic housing is to injection mold a thermoplastic material in which plastic pellets are heated under pressure until they become a viscous liquid and then inject the viscous liquid into a mold having an inner cavity which is complementary to the shape of the housing to be formed. The problem with injection molding, however, is that the injected plastic is under high pressure and at high temperatures which are harmful or destructive to various electronic components and therefore it is not common to encapsulate electronic components in a thermoplastic material using an injection molding process. In the transfer mold process, however, a thermoset material, in which a resin and a hardener chemically react is utilized. This process does not require that the mold be preheated to temperatures that are destructive to electronic components or require that the liquefied plastic be subjected to intense pressure and is therefore suitable for encapsulating electronic components. The thermoset chemicals used in a transfer molding process, however, are considerably more expensive than the thermoplastic chemicals used in an injection molding process, and as a result, a product requiring a housing made of a thermoset plastic can be considerably more expensive to manufacture than a thermoplastic housing made with an injection molding process.

Although a thermoplastic and injection molding are unsuitable for encapsulating electronic components, the process is suitable for making moveable plastic parts, such as the parts of a fuel level detector to detect the level of a fuel in a fuel tank. It would be desirable, therefore, to provide a method whereby a product having mechanical and electrical components can be manufactured at a minimal expense.

### SUMMARY OF THE INVENTION

Briefly, the present invention is embodied in a method of manufacturing a product having at least one electronic component. The method is best suited for manufacturing a product having a mechanically functional enclosure, such as the housing of a fuel level sensor. In accordance with the invention, a first mold is provided for forming a first housing that incorporates the mechanically functional features of the device. The first housing, which also has a cavity therein, is formed by injection molding a thermoplastic material into the first mold. Thereafter, a second mold is provided for forming a second housing in which the electronic components of the device are inserted for encapsulating. A thermoset material is then injected into the second mold in a transfer molding process to form a second housing. The second housing is inserted into the cavity of the first housing.

Preferably the first mold for forming the first housing includes an inner mass that is complementary in shape to at least a portion of the outer shape of the second housing such that the first housing is formed with a cavity therein that is complementary to the shape to a portion of the second housing. Prior to injecting material into the first mold at least one lead is inserted therein. In the preferred embodiment, a lead frame that includes including a plurality of leads is inserted into the first mold. A thermoplastic material is then injected into the first mold and allowed to harden, after which the first housing is removed. At least one electronic component is thereafter attached to the lead or leads retained in the first housing.

A second mold is then provided for forming a second housing. The second mold is adapted to receive the first housing including the lead frame molded therein. Upon receipt of the first housing into the second mold, the electronic components connected to the leads of the lead frame will be positioned within the inner opening defined within the second mold. A transfer molding process is used in which a thermoset material is injected into the inner opening of the second mold to form a second housing. Upon removal of the completed part from the second mold, the electronic components will be embedded in a second housing and the second housing will be, in turn, bonded into the cavity of the first housing.

### BRIEF DESCRIPTION OF THE DRAWINGS

A better understanding of the present invention will be had after a reading of the following detailed description taken in conjunction with the drawings wherein:

FIG. 1 is a cross-sectional view of a fuel tank having therein a fuel level detector manufactured in accordance with the present invention;

FIG. 2 is an isometric view of the fuel level sensor shown in FIG. 1;

FIG. 3 is an exploded view of the fuel level sensor as shown in FIG. 2;

FIG. 4 is a top-elevational view of the fuel level sensor shown in FIG. 2;

FIG. 5 is a cross-sectional view of the fuel level sensor as shown in FIG. 4 taken through line 5-5 thereof;

FIG. 6 is a bottom view of the rotor of the fuel level sensor shown in FIG. 2;

FIG. 7 is an isometric view of the rotor shown in FIG. 6;

FIG. 8 is a front elevational view of the housing for the fuel level sensor shown in FIG. 2;

FIG. 9 is a side elevational view of the housing shown in FIG. 8;

FIG. 10 is a top view of a lead frame for insertion in the housing in FIG. 8;

FIG. 11 is an enlarged isometric view of an inner housing portion of the housing shown in FIG. 8;

FIG. 12 is a cross sectional view of the inner housing shown in FIG. 11;

FIG. 13 is an enlarged cross-sectional view of a first and a second mold used to form an outer housing portion for the housing shown in FIG. 8;

FIG. 14 is a front elevational view of one of the molds depicted in FIG. 13 showing the contour of the cavity therein;

FIG. 15 is a front elevational view of the second mold depicted in FIG. 13 showing the contour of the cavity therein;

FIG. 16 is a front elevational view of the outer housing after being removed from the molds shown in FIG. 13;

FIG. 17 is a cross sectional view of a third and fourth molds used to form an inner housing portion shown in FIG. 11, and

FIG. 18 is a block diagram of the method of making the housing shown in FIG. 16.

### DETAILED DESCRIPTION OF PREFERRED EMBODIMENT

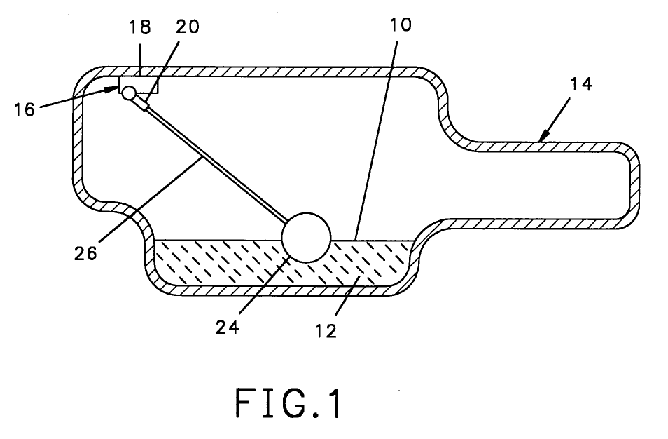

Referring to FIG. 1, to measure the fuel level 10 of fuel 12 in a tank 14 of a motor vehicle, not shown, a fuel level sensor 16 is provided that includes a stationary housing 18 and a rotor 20. The rotor 20 is rotated with respect to the housing by the movement of a float 24 attached to the rotor by means of a rod 26. Where the fuel level sensor 16 includes electronic components, the electronic components of the sensor 16 will deteriorate rapidly when exposed to the corrosive effects of the fuel 12 in the tank 14 unless those electronic components are encapsulated in a plastic housing or the like.

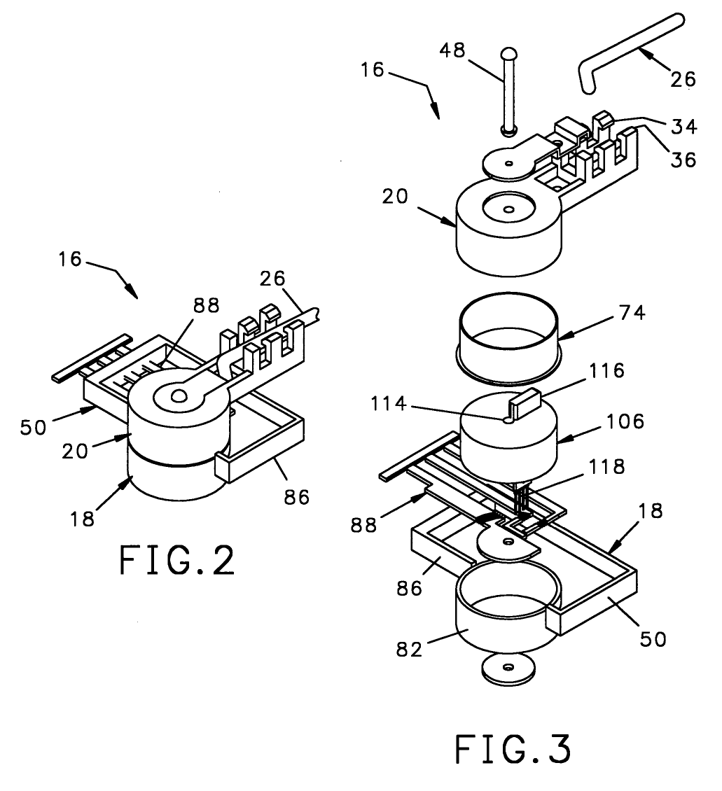

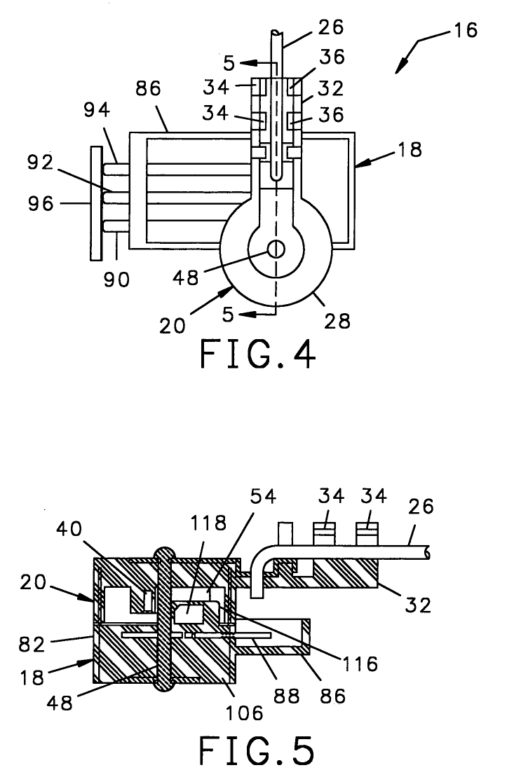

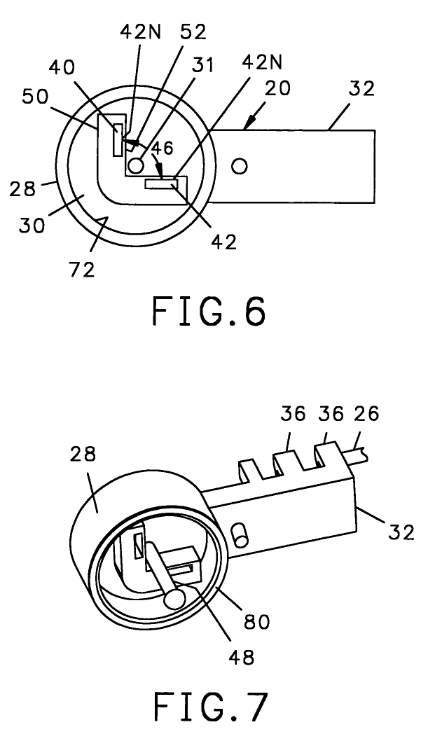

Referring to FIGS. 2 through 7, the rotor 20 of the fuel level sensor 10 includes a tubular sleeve 28 having an end wall 30, and extending from the tubular sleeve 28 is an elongate arm 32 to which the rod 26 is attached by a plurality of pairs of opposing claws 34, 36. Extending axially through the transverse end wall 30 is an axial hole 38, and extending through that hole 38 is an elongate pin 48. Mounted to the inner surface of the end wall 30 are a pair of permanent magnets 40, 42 with the north poles 40N, 42N thereof oriented at approximately ninety degrees to each other through an arc that extends around the axis of the sleeve 28.

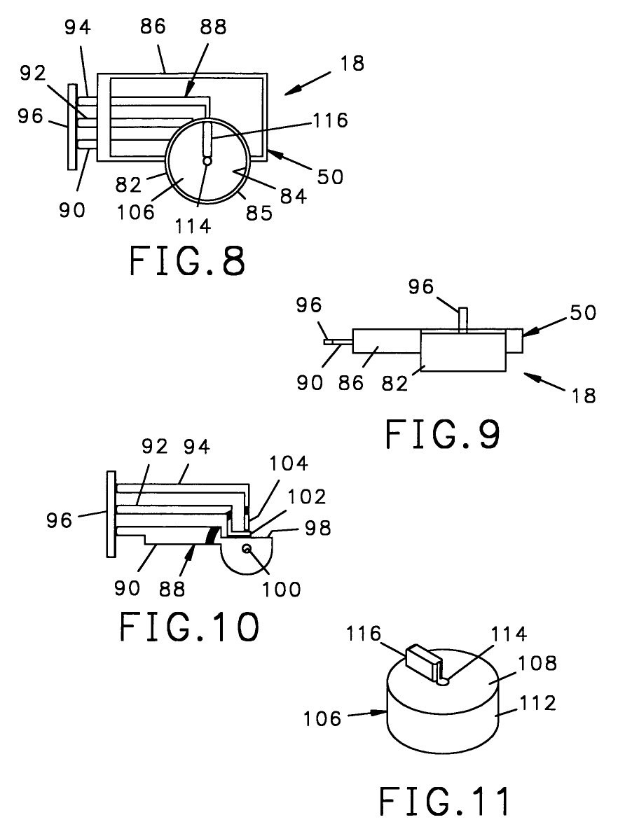

Referring to FIGS. 8 through 11, the housing 18 has a body 50 that includes cylindrical sleeve 82 having a cylindrical inner wall 84 and a coaxial cylindrical outer wall 85. Extending from diametrically opposing portions of the cylindrical outer wall 85 of the body 50 are portions of a generally rectangular frame 86 having embedded therein a metal lead frame 88. The lead frame 88 includes a plurality of leads of which three are depicted, namely leads 90, 92, and 94. Lead 90 is a ground lead and includes a generally planar contact pad 98 having a transverse hole 100 therethrough through which a portion of the pin 48 extends. Leads 92 and 94 connect to the electronic components of the fuel level sensor 16 as is further described below and have distal ends 102, 104 respectively for attachment to such components.

For the purposes of assembling the parts, the leads 90, 92, 94 are retained together by a tie bar 96, which connects the outer ends of the leads 90, 92, 94. After the housing 18 is fully assembled, as further provided below, the tie bar 96 can be broken free of the distal ends of the leads 90, 92, 94 leaving the leads spaced from one another so as not to be electrically connected to one another.

The body 50 includes attachment portions, such as holes in the frame 86 or tabs on the frame 86 or the cylindrical sleeve, not shown, for attaching the fuel level sensor 16 to the inner surface of a fuel tank 14. Within the tubular sleeve 82 is a generally cylindrical inner housing 106 having a planar forward surface 108, and extending axially through the center of the tubular inner housing 106, is an axially hole 114 for receiving the portion of the pin 48 extending axially from the sleeve 28 of the rotor 20. When the parts are assembled, as shown in FIGS. 2, 4 and 5, the pin 48 retains the cylindrical sleeve 28 of the rotor 20 in axial alignment with the cylindrical sleeve 82 of the housing 18.

Referring to FIGS. 3, 11 and 12, the inner housing 106 has extending axially from the forward surface 108 a projection 116 containing a Hall effect sensor 118. The Hall effect sensor 118 has contacts 120, 122, which are electrically connected, to the inner ends 102, 104 of leads 92, 94 by solderings 95, 96, or any other suitable means for electrically joining the parts. Accordingly, the leads 92, 94 are electrically connected to the Hall effect sensor 18 embedded in the projection 116 of the inner housing 106.

Referring to FIGS. 1, 2 and 3, when the rotor 16 is rotatably joined to the housing 18 by the pin 48, the projection 116 is oriented to extend between the north poles 40N, 42N of the magnets 40, 42 on the rotor 20. Accordingly, upward movement of the float 24 will move the Hall effect 118 towards the north pole of one of the magnets 40, 42 and downward movement of the float 24 will move the Hall effect sensor 118 towards the north pole of the second of the magnets 40, 42. When the leads 92, 94 are connected into appropriate circuits for measuring the voltage or the current provided from the Hall effect sensor 118, the output form the Hall effect sensor 118 will be related to the volume of fuel 12 in the tank 14.

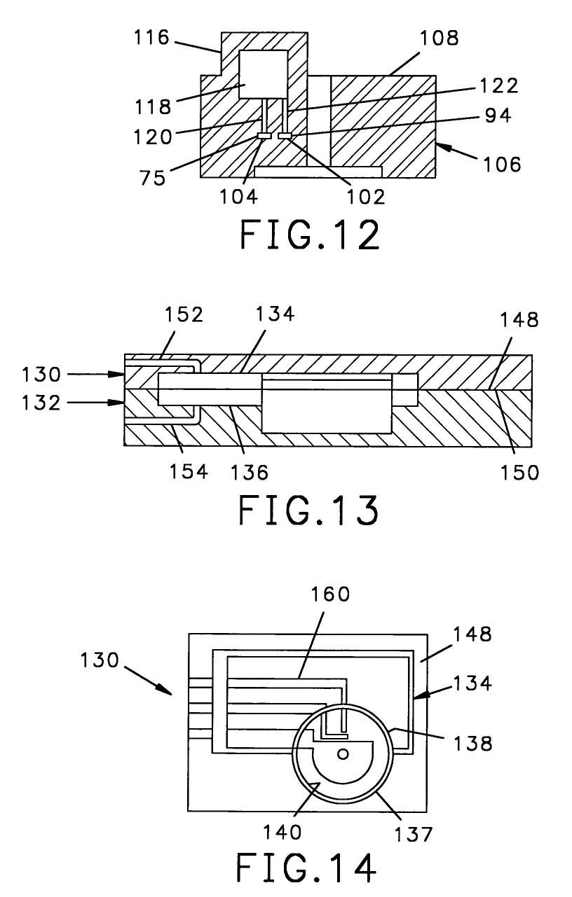

The chemicals in the fuel for motor vehicles are extremely corrosive and damaging to electronic components and therefore it is desirable that the Hall effect sensor 118, including the contacts 120, 122 and the solder joints 95, 96 be hermetically embedded in a suitable plastic inner housing 106. The electronics that make up the Hall effect sensor 118 are easily damaged by excessive heat and pressure applied to a mold, as would be needed to form the inner housing 106 from a thermoplastic using injection molding techniques. It is therefore not desirable to use injection molding to form the inner housing 106. It is customary to embed, and hermetically seal, electronic components in plastic parts made from a thermoset plastic using transfer molding techniques and therefore, the inner housing 106, as shown if FIGS. 11 and 12, is manufactured using a transfer molding process. Thermoset plastic, including the resin and hardener from which the plastic is made, is considerably more expensive than a thermoplastic material made with an injection molding. Specifically, the materials used in transfer molding cost approximately $4.00 to $5.00 per pound, whereas the chemicals used in injection molding cost between $1.00 and $1.25 per pound. The cost of making the housing 18 to which the rotor 20 is attached, therefore, can be greatly reduced by manufacturing the housing body 50 from a thermoplastic material using injection molding techniques.

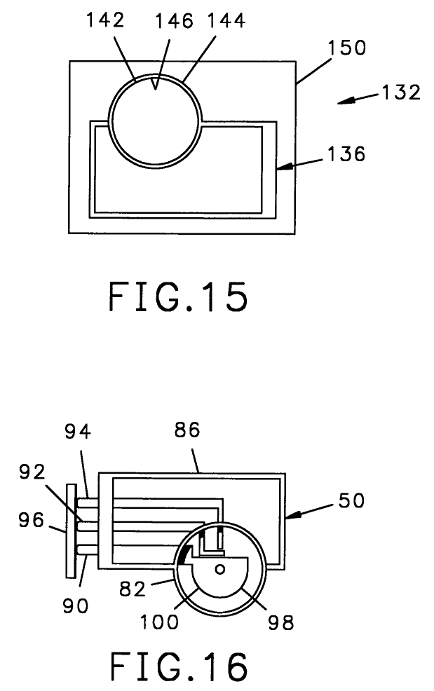

Referring to FIGS. 13 through 16, and 18, the housing body 50 is manufactured in a pair of opposing metal molds 130, 132 having cavities 134, 136 therein respectively. The cavity 134 of mold 130 includes a generally annular groove 137 defined by cylindrical wall 138, which is generally complimentary to the outer wall 85 of the tubular portion 82, and co-axial with the cylindrical wall 138, a second cylindrical wall 140 complimentary to cylindrical inner wall 84 of sleeve 82. The depth of groove 137 is equal to the distance of the lead frame 88 from one wall 141 of the housing body 50, as will be apparent when taken into consideration with mold 132. The cavity 136 of mold 132 also has an annular groove 142 defined by walls 144 and 146 complimentary to portions of cylindrical walls 85, 86, and the depth of groove 142 is determined by the distance of the lead frame 88 from the opposing wall 147 of the housing body 50.

The molds 130, 132 have mating surfaces 148, 150 respectively which when in contact with each other form a seal allowing a thermoplastic material to be injected through suitable runners 152, 154 extending from a hopper, not shown, and pressure chamber, not shown, in which pellets of thermoplastic material, not shown, are melted. In the immediate proximity of mating surface 148, cavity 134 has an enlarged indentation 160 that is complementary in shape to the perimeter to at least a portion of the lead frame 88 such that the lead frame 88 may be positioned in the indentation 160 before the mating surfaces 148, 150 are engaged to each other.

To manufacture the housing body 50, a lead frame 88 is positioned in the indentation 160 of mold 130 and the molds 130, 132 are assembled to each other with the mating surfaces 138, 140 forming a seal to retain liquefied thermoplastic material within the cavities 134, 136. Thereafter, liquefied plastic thermoplastic material is injected through the runners 152, 154 and into the cavities 134, 136. The liquefied thermoplastic is then permitted to cool after which a formed housing body 50, as depicted in FIG. 16, is removed from the molds 130, 132.

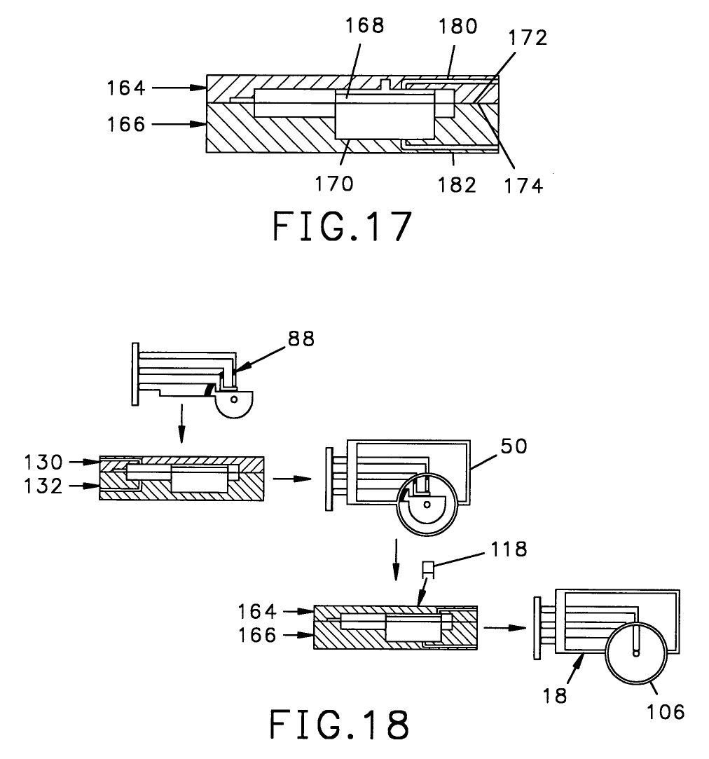

Referring to FIGS. 12, 17 and 18, to form the inner housing 106 within the tubular portion 82 of the housing body 50 third and fourth molds 164, 166 having inner cavities 168, 170 therein respectively, and having opposing mating surfaces 172, 174, are provided. Mold 164 includes a portion of the cavity 168 adapted to receive the cylindrical outer wall 85 of the sleeve 82 such that the sleeve 82 of the housing body 50 is insertable into the cavity 168 of the third mold body 164. The cavity 170 of the fourth mold body 166 is complementary in shape to the outer surface of the projection 116 extending from the forward surface 108 of the inner housing 106. The third and fourth mold bodies 164, 166 further have feed lines 180, 182 through which a liquefied thermoset material, including a suitable resin and hardener into the cavities 168, 170 thereof.

To form the inner housing 106, the contacts 120, 122 of a Hall effect sensor 118 are first soldered, forming solderings 95, 96, to connect the contact ends 102, 104 of leads 92, 94 thereto. Thereafter, the tubular sleeve 82 of the housing body 50 is assembled into the cavity 168 of the third mold 164 with the Hall effect sensor 118 extending into the portion of the cavity 170 of the fourth mold 166. The mating surfaces 172, 174 of the third and fourth molds 162, 168 are then engaged with each other after which the resin and hardener of a thermoset material is injected through the feeder lines 180, 182 until the cavities 168, 170 are filled with material thereby encasing the Hall effect sensor 118. After the plastic hardens a completed housing 18 is removed from the molds 164, 166.

While the present invention has been described with respect to a single embodiment, it will be appreciated that many modifications and variations may be made without departing from the true spirit and scope of the invention. It is therefore the intent of the appended claims to cover all such modifications and variations which fall within the true spirit and scope of the invention.

1. A method of manufacturing an encapsulated electronic component comprising the steps of
providing a first mold for forming a first housing where said first housing has a cavity therein,
inserting at least one lead into said first mold,
injection molding a thermoplastic material into said first mold,
removing said first housing from said first mold,
providing a second mold for forming a second housing wherein said first housing is received within said second mold and said cavity of said first housing defines a portion of an inner opening of said second mold,
attaching at least one electronic component to said at least one lead,
inserting said first housing into said second mold, and
transfer molding a thermoset material into said inner opening of said second mold to form a second housing wherein said thermoset material encapsulates said at least one electronic component.

2. The method of claim 1 wherein said at least one lead comprises a lead frame.

3. The method of claim 1 wherein said at least one electronic component is positioned within said cavity of said first housing.

4. The method of claim 1 wherein said thermoset material encapsulates said at least one electronic component.

5. A method of manufacturing a product having at least one electronic component encapsulated therein comprising the steps of
providing a first mold for forming a first housing where said first housing has a cavity therein,
injection molding a thermoplastic material into said first mold to form a first housing,
providing a second mold for forming a second housing,
inserting said at least one electronic component in said second mold,
transfer molding a thermoset material into said second mold and around at least a portion of said electronic component to form a second housing, and
bonding said second housing into said cavity of said first housing.

6. A method of manufacturing a product having at least one electronic component encapsulated therein comprising the steps of
injection molding a first housing from a thermoplastic material where said first housing has a cavity therein,
transfer molding a second housing from a thermoset material where said second housing encapsulates said at least one electronic component, and
bonding said second housing into said cavity of said first housing.

7-8. (canceled)

9. A liquid level detector for use within a fuel tank, said liquid level detector comprising
a Hall Effect detector,
at least one magnet moveable with respect to said Hall effect detector,
said Hall effect detector encapsulated in an inner housing,
said inner housing made of a transfer molded thermoset material,
an outer housing formed around a part of said inner housing,
said outer housing formed of a thermoplastic material,
said outer housing including means for moveably retaining an arm connected to a float wherein movement of said float causes movement of said at least one magnet with respect to said Hall effect sensor.
